(19) United States
(12) Patent Application Publication
(10) Pub. No.: US 2010/0048298 A1
(43) Pub. Date: Feb. 25, 2010

(54) SUBSTANTIALLY TRANSPARENT ELECTRICAL COMPONENTS WITHIN A WAGERING GAME MACHINE

(75) Inventors: Charles R. Bleich, Cary, IL (US); Stephen A. Canterbury, Antioch, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS Gaming Inc., Waukegan, IL (US)

(21) Appl. No.: 12/447,282

(22) PCT Filed: Nov. 8, 2007
(86) PCT No.: PCT/US07/23501

§ 371 Date: Apr. 27, 2009

Related U.S. Application Data
(60) Provisional application No. 60/864,994, filed on Nov. 9, 2006.

(51) Int. Cl. A63F 13/00

(52) U.S. Cl. 463/30; 463/37

(57) ABSTRACT

In some embodiments, an apparatus comprises a wagering game machine. The wagering game machine comprises a wagering game unit operable to receive a wager in association with a wagering game. The wagering game machine also comprises a display to display a randomly selected outcome of the wagering game. The wagering game machine comprises a controller to control the display. The controller comprises an electrical component embedded in the display, wherein the electrical component is substantially transparent to a part of the electromagnetic spectrum that is visible to a human eye.

### RELATED APPLICATION

This patent application claims the priority benefit of U.S. Provisional Patent Application Ser. No. 60/864,994 filed Nov. 9, 2006 and entitled “SUBSTANTIALLY TRANSPARENT ELECTRICAL COMPONENTS WITHIN A WAGERING GAME MACHINE”, which application is incorporated herein by reference.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2006, 2007, WMS Gaming, Inc.

### FIELD

Embodiments of the inventive subject matter relate generally to wagering game machines, and more particularly, to substantially transparent electrical components within a wagering game machine.

### BACKGROUND

Wagering game machine makers continually provide new and entertaining games. Reducing the footprint of wagering game machines allows more machines to be set up on a casino floor, thereby potentially increasing the revenue there from.

### BRIEF DESCRIPTION OF THE FIGURES

Embodiments of the invention are illustrated by way of example and not limitation in the Figures of the accompanying drawings in which:

FIG. 1 is a perspective view of a wagering game machine, according to example embodiments.

FIG. 2 illustrates a display of a wagering game machine that has substantially transparent electrical components, according to example embodiments.

FIG. 3 is a flow diagram for processing a display output signal for a wagering game using substantially transparent electrical components, according to example embodiments.

FIG. 4 is a flow diagram for processing a touch screen input for a wagering game using substantially transparent electrical components, according to example embodiments.

FIG. 5 shows another example embodiment of a wagering game machine that includes substantially transparent electrical components.

FIG. 6 is a block diagram illustrating a wagering game machine architecture, according to example embodiments.

### DESCRIPTION OF THE EMBODIMENTS

Systems, apparatus and methods for substantially transparent electrical components (such as transistors) in a wagering game machine are described herein. This description of the embodiments is divided into five sections. The first section describes an example wagering game machine. The second section describes an example of a display of a wagering game machine. The third section described example operations for substantially transparent electrical components in a display of a wagering game machine. The fourth section describes another example game machine and a wagering game architecture. The fifth section provides some general comments

Some embodiments include the incorporation of electrical components, which are substantially transparent to the part of the electromagnetic spectrum that is visible to human eye, to various parts of a wagering game machine. The electrical components may include simple components, integrated circuits, Large Scale Integrated (LSI) circuits, etc. (such as various types of transistors, inductors, resistors, capacitors, inverters, amplifiers, memory cells, processors, digital-to-analog converters, analog-to-digital converters, etc.). The electrical components may be placed into the different parts of the wagering game machine (such as in the display, art glass, various plastic components, etc.). For example, the control circuitry for the displays may be embedded therein, thereby potentially allowing the wagering game machines to be more compact. In particular, a separate controller card for the display may not be required. Such wagering game machines may have a smaller footprint, thereby enabling more wagering game machines on a casino floor.

### Example Wagering Game Machine

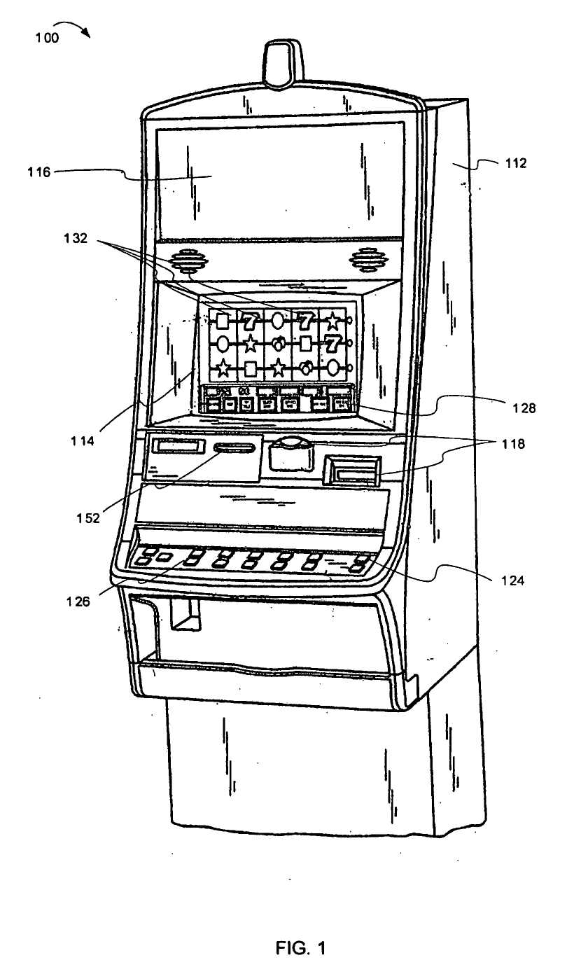

FIG. 1 is a perspective view of a wagering game machine, according to example embodiments. Referring to FIG. 1, a wagering game machine 100 is used in gaming establishments, such as casinos. According to embodiments, the wagering game machine 100 can be any type of wagering game machine and can have varying structures and methods of operation. For example, the wagering game machine 100 can be an electromechanical wagering game machine configured to play mechanical slots, or it can be an electronic wagering game machine configured to play video casino games, such as blackjack, slots, keno, poker, blackjack, roulette, etc.

The wagering game machine 100 comprises a housing 12 and includes input devices, including value input devices 118 and a player input device 124. For output, the wagering game machine 100 includes a primary display 114 for displaying information about a basic wagering game. The primary display 114 can also display information about a bonus wagering game and a progressive wagering game. The wagering game machine 100 also includes a secondary display 116 for displaying wagering game events, wagering game outcomes, and/or signage information. In some embodiments, various types of glass may be used in place or in addition to the secondary display 116. For example, this section of the wagering game machine 100 may be art glass. Lights may be positioned behind the art glass. Accordingly, parts of all of the art glass may be illuminated during operation of the wagering game machine 100. While some components of the wagering game machine 100 are described herein, numerous other elements can exist and can be used in any number or combination to create varying forms of the wagering game machine 100.

The value input devices 118 can take any suitable form and can be located on the front of the housing 112. The value input devices 118 can receive currency and/or credits inserted by a player. The value input devices 118 can include coin acceptors for receiving coin currency and bill acceptors for receiving paper currency. Furthermore, the value input devices 118 can include ticket readers or barcode scanners for reading information stored on vouchers, cards, or other tangible portable storage devices. The vouchers or cards can authorize access to central accounts, which can transfer money to the wagering game machine 100.

The player input device 124 comprises a plurality of push buttons on a button panel 126 for operating the wagering game machine 100. In addition, or alternatively, the player input device 124 can comprise a touch screen 128 mounted over the primary display 114 and/or secondary display 116.

The various components of the wagering game machine 100 can be connected directly to, or contained within, the housing 112. Alternatively, some of the wagering game machine's components can be located outside of the housing 112, while being communicatively coupled with the wagering game machine 100 using any suitable wired or wireless communication technology.

The operation of the basic wagering game can be displayed to the player on the primary display 114. The primary display 114 can also display a bonus game associated with the basic wagering game. The primary display 114 can include a cathode ray tube (CRT), a high resolution liquid crystal display (LCD), a plasma display, light emitting diodes (LEDs), or any other type of display suitable for use in the wagering game machine 100. Alternatively, the primary display 114 can include a number of mechanical reels to display the outcome. In FIG. 1, the wagering game machine 100 is an “upright” version in which the primary display 114 is oriented vertically relative to the player. Alternatively, the wagering game machine can be a “slant-top” version in which the primary display 114 is slanted at about a thirty-degree angle toward the player of the wagering game machine 100. In yet another embodiment, the wagering game machine 100 can exhibit any suitable form factor, such as a free standing model, bartop model, mobile handheld model, or workstation console model.

A player begins playing a basic wagering game by making a wager via the value input device 118. The player can initiate play by using the player input device's buttons or touch screen 128. The basic game can include arranging a plurality of symbols along a payline 132, which indicates one or more outcomes of the basic game. Such outcomes can be randomly selected in response to player input. At least one of the outcomes, which can include any variation or combination of symbols, can trigger a bonus game.

In some embodiments, the wagering game machine 100 can also include an information reader 152, which can include a card reader, ticket reader, bar code scanner, RFID transceiver, or computer readable storage medium interface. In some embodiments, the information reader 152 can be used to award complimentary services, restore game assets, track player habits, etc.

In some embodiments, different parts of the wagering game machine 100 may be made of an electro-luminance material. For example, the secondary display 116, the value input device 118, the information reader 152, the button panel 126, etc.

### Display of a Wagering Game Machine

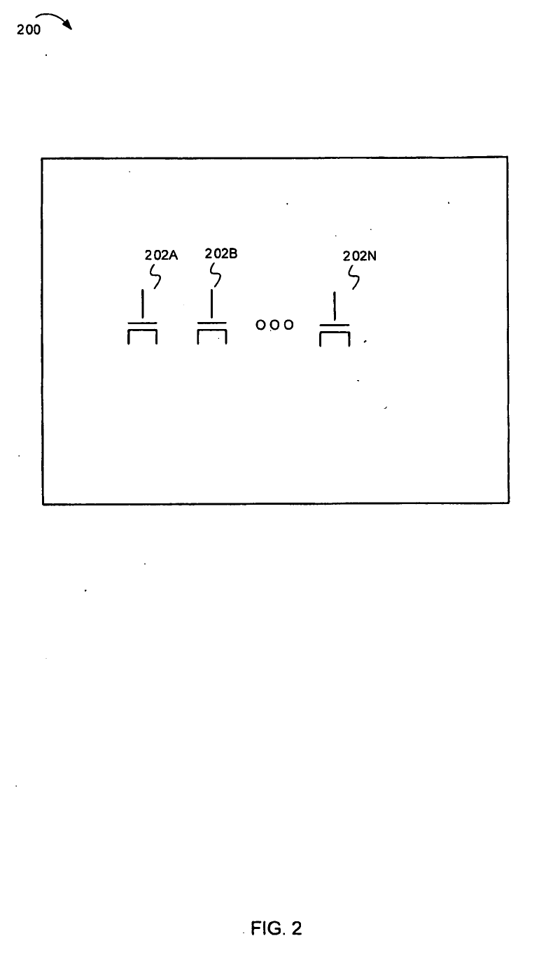

In some embodiments, various parts of the wagering game 100 may comprise substantially transparent electrical components. These electrical components, which may be embedded on the displays of a wagering game machine, may be part of control circuitry for such displays. For example with reference to FIG. 1, these electrical components may be embedded in the primary display 114, the secondary display 116, the touch screen 128, a display of a graphical button on the button panel 126, etc. FIG. 2 illustrates a display of a wagering game machine that has substantially transparent electrical components, according to example embodiments. A display 200 includes a number of electrical components 202A-202N. In some embodiments, the display 200 may be a cathode ray tube (CRT), a high resolution liquid crystal display (LCD), a plasma display, light emitting diodes (LEDs), an organic light emitting diode (OLED) display or any other type of display suitable for use in the wagering game machine 100. The display 200 may include a display on a wagering game machine for displaying information for a wagering game including the symbols of reels, wagering game events, wagering game outcomes, signage information, etc. (see the primary display 114 and the secondary display 116 of FIG. 1). The display 200 may be representative of the display on a graphical button. For example, the display 200 may be a display on one of the buttons on the button panel 126 of FIG. 1.

While displayed as a transistor, the electrical components 202 may be any type of electrical component. For example, the electrical components 202 may be substantially transparent capacitors, resistors, inductors, inverters, etc. In some embodiments, the electrical components 202 may be different types of integrated circuits, including Large Scale Integrated (LSI) circuits. For example, the electrical components may include processor, a digital-to-analog converter, an analog-to-digital converter, a smoothing circuitry, shifting circuitry, analog amplifiers, memory cells (such as dynamic random access memory (DRAM) cells), etc. In some embodiments, the electrical components 202 may be thin film transistors (TFT). The electrical components 202 may be representative of integrated circuits, monolithic devices, semiconductor devices, microelectronic devices, etc. In some embodiments, the electrical components 202 are part of a optoelectronic device (such as an active-matrix liquid crystal display).

In some embodiments, the electrical components 202 may have an optical transmission of approximately 50% or greater, relative to the visible part of the electromagnetic spectrum. In some embodiments, the electrical components 202 may have an optical transmission of approximately 70% or greater, relative to the visible part of the electromagnetic spectrum. In some embodiments, the electrical components 202 may have an optical transmission of approximately 90% or greater, relative to the visible part of the electromagnetic spectrum.

In some embodiments, the material of the electrical components 202 may include substantially transparent materials (such as ZnO, SnO₂, or In₂O₃). For example, the electrical components 202 may be transistors that comprise a channel layer that is substantially transparent. The material of the channel layer may include ZnO, SnO₂, or In₂O₃. In some embodiments, the material ZnO, SnO₂, or In₂O₃ may be formed by annealing (such as rapid thermal annealing). In some embodiments, a layer of ZnO, SnO₂, or In₂O₃ may be deposited using sputter deposition. Such a fabrication may occur in an atmosphere that includes a sputter gas and a film-modifying gas. Sputter gases may include Ar, Ne, etc.

In some embodiments, the film-modifying gas may include an oxidative gas whose molecules, atoms or ions are incorporated into the film so that they occupy oxygen vacancies or deficiencies in the film. Oxidative gases may include O₂, N₂O, etc. Another film-modifying gas may be a dopant gas whose molecules, atoms or ions are incorporated into the film so that they increase the resistivity of the film. Dopant gases may include N₂, NH₃, etc.

The electrical components 202 may be a transistor having a channel layer (as described above). A thickness of the channel layer may be in a range of approximately 10 to about 500 nm. A length of the channel layer may be in a range of approximately 1,000 to about 100,000 nm.

In some embodiments, the material of the electrical components 202 may include substantially transparent materials (such as aluminum-titanium oxide (Al₂O₃/TiO₂), Al₂O₃, MgO, SiO₂, silicon nitride, and silicon oxynitride). For example, the electrical components 202 may be transistors that comprise a gate layer that is substantially transparent. In some embodiments, the electrical components 202 may include a gate layer that is adjacent to the channel layer (described above). The gate layer may include substantially transparent materials (such as aluminum-titanium oxide (Al₂O₃/TiO₂), Al₂O₃, MgO, SiO₂, silicon nitride, and silicon oxynitride). In some embodiments, the thickness of the gate insulator layer may be in a range of approximately 10 to 300 nm.

In some embodiments, the material of the electrical components 202 may include substantially transparent materials (such as indium-tin oxide (ITO), ZnO, SnO₂ and In₂O₃). For example, the electrical components 202 may include field effect transistors (FETs) that include source/drain terminals. In some embodiments, the source/drain terminals may include n-type conductors such as indium-tin oxide (ITO), ZnO, SnO₂, In₂O₃ etc. Especially useful materials for the source and drain are those that can inject (and extract) electrons into the channel layer insulating material. In some embodiments, the source/drain terminals may include electron injection materials include indium-tin oxide, LaB₆, and ZnO:Al.

In some embodiments, the material of the electrical components 202 may include substantially transparent materials (such as indium-tin oxide (ITO), ZnO, SnO₂, and In₂O₃). For example, the electrical components 202 may include a gate electrode that may include substantially transparent, n-type conductors such as indium-tin oxide (ITO), ZnO, SnO₂, In₂O₃, etc. The thickness of the gate electrode may be in a range of approximately 50 to 1000 nm. The gate electrode may be introduced into the structure by chemical vapor deposition, sputtering, evaporation and/or doping.

In some embodiments, the electrical components 202 may be used in an active-matrix liquid crystal display. The electrical components 202 may be embedded in the display and used to control pixels therein. For example, the electrical components 202 may be transistors that are coupled to a pixel, thereby forming a transistor/pixel cell. A drain electrode of the transistor may be coupled to the pixel. A gate electrode of the transistor may be coupled to a control line that receives an on/off control signal for the transistor. A source electrode of the transistor is coupled to a data line that receives a signal for controlling the pixel. Therefore, in operations, a wagering game application may be executed. An output of the execution may be a game display signal to control the display. The game display signal may be transmitted to the substantially transparent transistors in the display. The transistors may control the pixels based on the game display signal (such as on/off, color output, etc.).

While the electrical components have been described as being embedded in a display, embodiments are not so limited. In some embodiments, the electrical components may be applied on various plastic substrates in the wagering game machine. For example, the electrical components may be within reel strips in the mechanical reel wagering game machines. In some embodiments, the electrical components may be embedded in the bezels that surround various components of the wagering game machine. For example, the electrical components may be in the bezels of the value input devices 118, the information reader 152, etc. Accordingly, the control circuitry for illuminating such bezels may be embedded therein. The bezels may be composed of different material.(such as glass, plastic, metal, etc.).

In some embodiments, the electrical components may be embedded in various types of glass in the wagering game machine. For example, the wagering game machine may include art glass that may be illuminated during operation. Accordingly, these electrical components for the control of the illumination may be embedded in the art glass. In some embodiments, the electrical components may be representative of at least part of a touch sensor. For example, electrical components of the touch sensors may be embedded in the art glass, buttons, displays, etc on the wagering game machine.

In some embodiments, the electrical components may be embedded in electro-luminance material. For example, the electrical components may be in electro-luminance material used for the secondary display 116, the value input device 118, the information reader 152, the button panel 126, etc.

### Example Operations for Substantially Transparent Electrical Components in a Wagering Game Machine Display

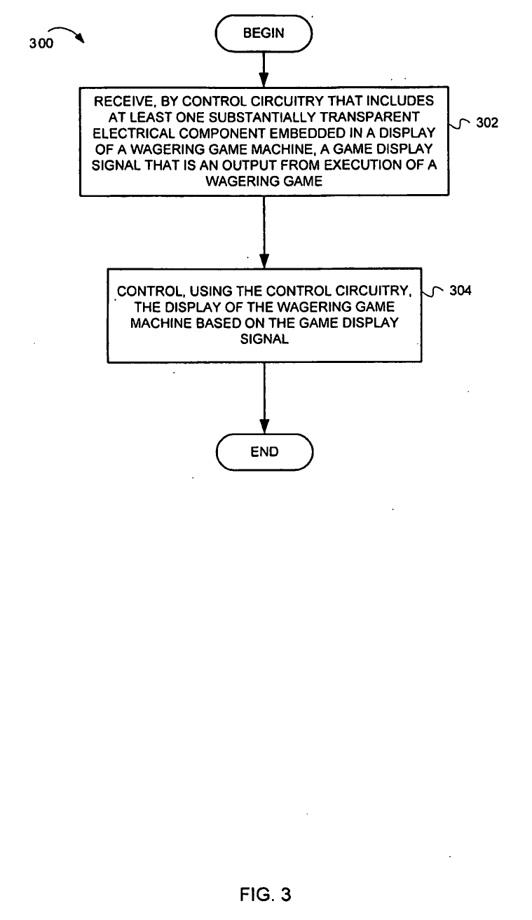

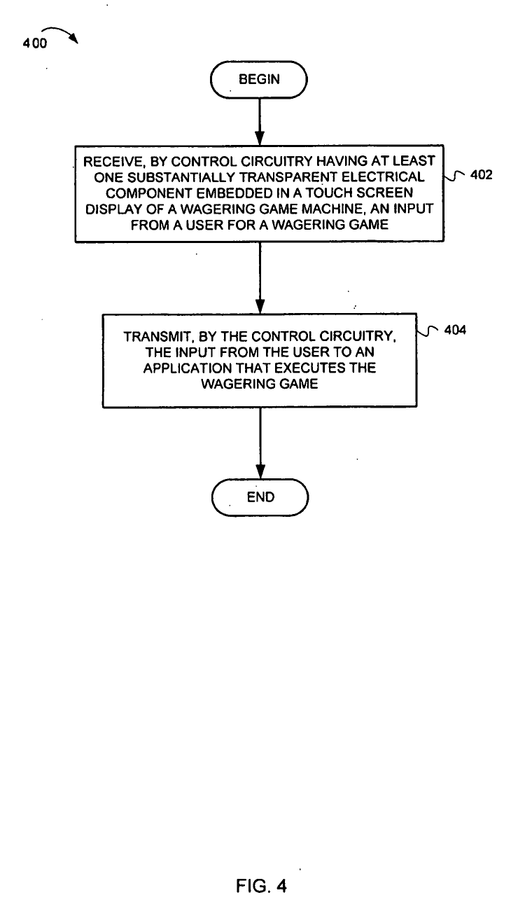

The substantially transparent electrical components may be operated in a number of applications in a wagering game machine. FIGS. 3 and 4 illustrate some example applications. FIG. 3 is a flow diagram for processing a display output signal for a wagering game using substantially transparent electrical components, according to example embodiments. FIG. 3 illustrates operations that may be executed by components within a wagering game machine 102 (shown in FIG. 1). The flow diagram 300 of FIG. 3 is also described relative to the display 200 (shown in FIG. 2). The flow diagram commences at block 302.

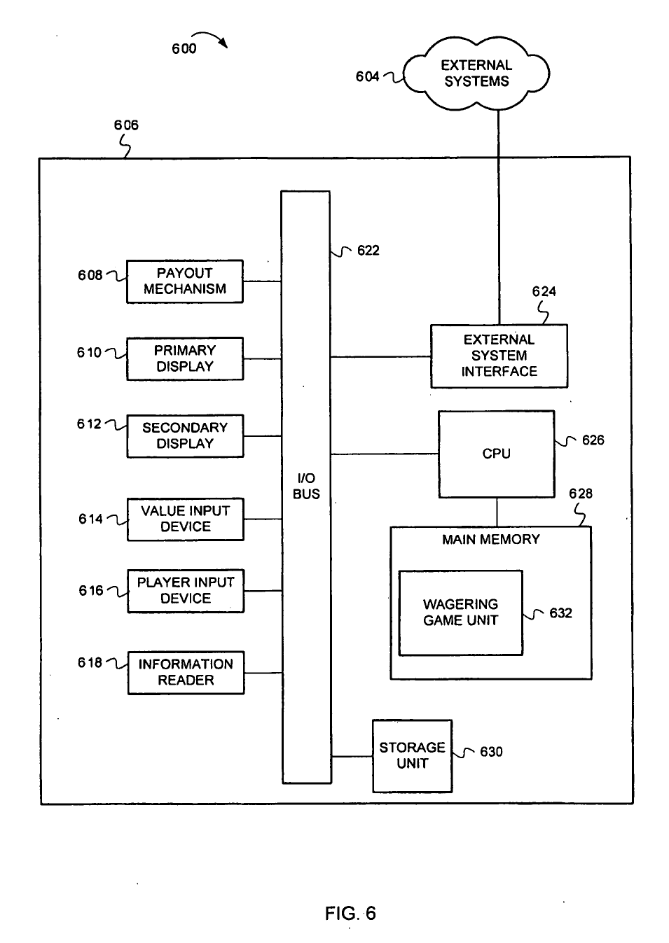

At block 302, a game display signal is received by control circuitry that includes at least one substantially transparent electrical component embedded in a display of a wagering game device. The game display signal is an output from execution of a wagering game in the wagering game machine. In some embodiments, a processor may be executing an application for the wagering game (for example see the wagering game machine architecture illustrated in FIG. 6). Such execution may include updating the display on the wagering game machine. For example, the display may include the symbols of reels, wagering game events, wagering game outcomes, signage information, etc. The processor may transmit the game display signal to control circuitry for the display. At least part of the control circuitry may be substantially transparent electrical components that are embedded in the display (as described above). The flow continues at block 304.

At block 304, the display of the wagering game machine is controlled, using the control circuitry, based on the game display signal. As described above, for example, one or more transistor/pixel cells may be part of the display of the wagering game machine. The transistors may be substantially transparent and controlling the pixels (on/off, color output, etc.). The operations of the flow diagram 300 are complete.

Another application of the substantially transparent electrical components may relate to processing/controlling of input from a touch screen on a wagering game machine. FIG. 4 is a flow diagram for processing a touch screen input for a wagering game using substantially transparent electrical components, according to example embodiments. FIG. 4 illustrates operations that may be executed by components within a wagering game machine 102 (shown in FIG. 1). The flow diagram 400 of FIG. 4 is also described relative to the display 200 (shown in FIG. 2). The flow diagram commences at block 402.

At block 402, an input is received from a user of a wagering game being executed on a wagering game machine. The input is received by control circuitry having at least one substantially transparent electrical component embedded in a touch screen display of a wagering game machine. With reference to FIG. 1, the touch screen 128 may include one or more substantially transparent electrical components. The one or more electrical components may be used to determine whether a user touches the touch screen for input into the wagering game. The electrical components may also be used to determine which part of the touch screen the user selected. For example, the user may use the touch screen for selecting the amount of a bet, for placing a bet, for starting a wagering game, for cashing out, etc. The flow continues at block 404.

At block 404, the input from the user is transmitted, by the control circuitry, to an application that executes the wagering game. In some embodiments, a processor may be executing an application for the wagering game (for example see the wagering game machine architecture illustrated in FIG. 6). Such execution may include receiving inputs from the user through the touch screen. For example, the user input may be the placing of a bet for the wagering game. Therefore, the processor may process the user input as part of the execution of the wagering game. The operations of the flow diagram 400 are complete.

In some embodiments, the operations of the flow diagram 300 and the flow diagram 400 may be practiced together. Similar operations by control circuitry embedded in other displays on the wagering game machine may be performed. For example, substantially transparent electrical components may control the pixels (e.g., on/off, color output, etc.) on the display of the graphical button.

### Example Wagering Game Machine and Architecture

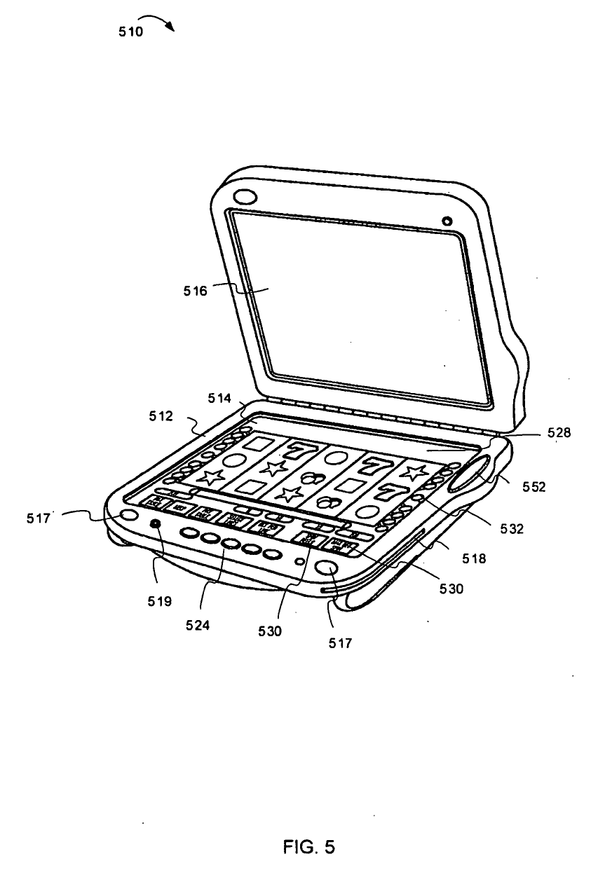

Other types of wagering game machines may include substantially transparent electrical components. FIG. 5 shows another example embodiment of a wagering game machine that includes substantially transparent electrical components. Like free standing wagering game machines, in a handheld or mobile form, the wagering game machine 510 can include any suitable electronic device configured to play a video casino games such as blackjack, slots, keno, poker, blackjack, and roulette. The wagering game machine 510 comprises a housing 512 and includes input devices, including a value input device 518 and a player input device 524. For output, the wagering game machine 510 includes a primary display 514, a secondary display 516, one or more speakers 517, one or more player-accessible ports 519 (e.g., an audio output jack for headphones, a video headset jack, etc.), and other conventional I/O devices and ports, which may or may not be player-accessible. In the embodiment depicted in FIG. 5, the wagering game machine 510 comprises a secondary display 516 that is rotatable relative to the primary display 514. The optional secondary display 516 can be fixed, movable, and/or detachable/attachable relative to the primary display 514. Either the primary display 514 and/or secondary display 516 can be configured to display any aspect of a non-wagering game, wagering game, secondary game, bonus game, progressive wagering game, group game, shared-experience game or event, game event, game outcome, scrolling information, text messaging, emails, alerts or announcements, broadcast information, subscription information, and wagering game machine status.

The player-accessible value input device 518 can comprise, for example, a slot located on the front, side, or top of the casing 512 configured to receive credit from a stored-value card (e.g., casino card, smart card, debit card, credit card, etc.) inserted by a player. The player-accessible value input device 518 can also comprise a sensor (e.g., an RF sensor) configured to sense a signal (e.g., an RF signal) output by a transmitter (e.g., an RF transmitter) carried by a player. The player-accessible value input device 518 can also or alternatively include a ticket reader, or barcode scanner, for reading information stored on a credit ticket, a card, or other tangible portable credit or funds storage device. The credit ticket or card can also authorize access to a central account, which can transfer money to the wagering game machine 510.

Still other player-accessible value input devices 518 can require the use of touch keys 530 on the touch-screen display (e.g., primary display 514 and/or secondary display 516) or player input devices 524. Upon entry of player identification information and, preferably, secondary authorization information (e.g., a password, PIN number, stored value card number, predefined key sequences, etc.), the player can be permitted to access a player's account. As one potential optional security feature, the wagering game machine 510 can be configured to permit a player to only access an account the player has specifically set up for the wagering game machine 510. Other conventional security features can also be utilized to, for example, prevent unauthorized access to a player's account, to minimize an impact of any unauthorized access to a player's account, or to prevent unauthorized access to any personal information or funds temporarily stored on the wagering game machine 510.

The player-accessible value input device 518 can itself comprise or utilize a biometric player information reader which permits the player to access available funds on a player's account, either alone or in combination with another of the aforementioned player-accessible value input devices 518. In an embodiment wherein the player-accessible value input device 518 comprises a biometric player information reader, transactions such as an input of value to the wagering game machine 510, a transfer of value from one player account or source to an account associated with the wagering game machine 510, or the execution of another transaction, for example, could all be authorized by a biometric reading, which could comprise a plurality of biometric readings, from the biometric device.

Alternatively, to enhance security, a transaction can be optionally enabled only by a two-step process in which a secondary source confirms the identity indicated by a primary source. For example, a player-accessible value input device 518 comprising a biometric player information reader can require a confirmatory entry from another biometric player information reader 552, or from another source, such as a credit card, debit card, player ID card, fob key, PIN number, password, hotel room key, etc. Thus, a transaction can be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 518 can be provided remotely from the wagering game machine 510.

The player input device 524 comprises a plurality of push buttons on a button panel for operating the wagering game machine 510. In addition, or alternatively, the player input device 524 can comprise a touch screen mounted to a primary display 514 and/or secondary display 516. In some embodiments, the touch screen is matched to a display screen having one or more selectable touch keys 530 selectable by a user's touching of the associated area of the screen using a finger or a tool, such as a stylus pointer. A player enables a desired function either by touching the touch screen at an appropriate touch key 530 or by pressing an appropriate push button on the button panel. The touch keys 530 can be used to implement the same functions as push buttons. Alternatively, the push buttons 526 can provide inputs for one aspect of the operating the game, while the touch keys 530 can allow for input needed for another aspect of the game. The various components of the wagering game machine 510 can be connected directly to, or contained within, the casing 512, as seen in FIG. 5, or can be located outside the casing 512 and connected to the casing 512 via a variety of wired (tethered) or wireless connection methods. Thus, the wagering game machine 510 can comprise a single unit or a plurality of interconnected (e.g., wireless connections) parts which can be arranged to suit a player's preferences.

The operation of the basic wagering game on the wagering game machine 510 is displayed to the player on the primary display 514. The primary display 514 can also display the bonus game associated with the basic wagering game. The primary display 514 preferably takes the form of a high resolution LCD, a plasma display, an LED, or any other type of display suitable for use in the wagering game machine 510. The size of the primary display 514 can vary from, for example, about a 2-3″ display to a 15″ or 17″ display. In at least some embodiments, the primary display 514 is a 7″-10″ display. In some embodiments, the size of the primary display can be increased. Optionally, coatings or removable films or sheets can be applied to the display to provide desired characteristics (e.g., anti-scratch, anti-glare, bacterially-resistant and anti-microbial films, etc.). In at least some embodiments, the primary display 514 and/or secondary display 516 can have a 16:9 aspect ratio or other aspect ratio (e.g., 4:3). The primary display 514 and/or secondary display 516 can also each have different resolutions, different color schemes, and different aspect ratios.

As with the free standing embodiments a wagering gaming machine, a player begins play of the basic wagering game on the wagering game machine 510 by making a wager (e.g., via the value input device 518 or an assignment of credits stored on the handheld gaming machine via the touch screen keys 530, player input device 524, or buttons 526) on the wagering game machine 510. In some embodiments, the basic game can comprise a plurality of symbols arranged in an array, and includes at least one payline 532 that indicates one or more outcomes of the basic game. Such outcomes can be randomly selected in response to the wagering input by the player. At least one of the plurality of randomly selected outcomes can be a start-bonus outcome, which can include any variations of symbols or symbol combinations triggering a bonus game.

In some embodiments, the player-accessible value input device 518 of the wagering game machine 510 can double as a player information reader 552 that allows for identification of a player by reading a card with information indicating the player's identity (e.g., reading a player's credit card, player ID card, smart card, etc.). The player information reader 552 can alternatively or also comprise a bar code scanner, RFID transceiver or computer readable storage medium interface. In some embodiments, the player information reader 552 comprises a biometric sensing device.

As described above, substantially transparent electrical components may communicate with other electronics in a wagering game machine architecture (such as a processor executing a wagering game application). FIG. 6 is a block diagram illustrating a wagering game machine architecture, according to example embodiments. As shown in FIG. 6, the wagering game machine 606 includes a central processing unit (CPU) 626 connected to main memory 628, which includes a wagering game unit 632. The wagering game unit 632 may be representative of a wagering game application for execution of a wagering game (as described above). In some embodiments, the wagering game unit 632 can present wagering games, such as video poker, video black jack, video slots, video lottery, etc., in whole or part.

The CPU 626 is also connected to an input/output (I/O) bus 622, which facilitates communication between the wagering game machine's components. The I/O bus 622 is connected to a payout mechanism 608, primary display 610, secondary display 612, value input device 614, player input device 616, information reader 618, and storage unit 630. The player input device 616 can include the value input device 614 to the extent the player input device 616 is used to place wagers. The I/O bus 622 is also connected to an external system interface 624, which is connected to external systems 604 (e.g., wagering game networks).

In some embodiments, the wagering game machine 606 can include additional peripheral devices and/or more than one of each component shown in FIG. 6. For example, in one embodiment, the wagering game machine 606 can include multiple external system interfaces 624 and multiple CPUs 626. In some embodiments, any of the components can be integrated or subdivided. Additionally, in one embodiment, the components of the wagering game machine 606 can be interconnected according to any suitable interconnection architecture (e.g., directly connected, hypercube, etc.).

In some embodiments, any of the components of the wagering game machine 606 (e.g., the wagering game unit 632) can include hardware, firmware, and/or software for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

### General

In this detailed description, reference is made to specific examples by way of drawings and illustrations. These examples are described in sufficient detail to enable those skilled in the art to practice the inventive subject matter, and serve to illustrate how the inventive subject matter can be applied to various purposes or embodiments. Other embodiments are included within the inventive subject matter, as logical, mechanical, electrical, and other changes can be made to the example embodiments described herein. Features or limitations of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims.

Each of the embodiments described herein are contemplated as falling within the inventive subject matter, which is set forth in the following claims.

What is claimed is:

1. An apparatus comprising:
a wagering game machine comprising,
a wagering game unit operable to receive a wager in association with a wagering game;
a display to display a randomly selected outcome of the wagering game; and
a controller to control the display, the controller comprising an electrical component embedded in the display, wherein the electrical component is substantially transparent to a part of the electromagnetic spectrum that is visible to a human eye.

2. The apparatus of claim 1, wherein the display comprises an active-matrix liquid crystal display.

3. The apparatus of claim 1, wherein the electrical component has an optical transmission of approximately 50% or greater.

4. The apparatus of claim 1, wherein the electrical component has an optical transmission of approximately 90% or greater.

5. The apparatus of claim 1, wherein a material of the electrical component is selected from a group consisting of ZnO, SnO₂, and In₂O₃.

6. The apparatus of claim 1, wherein a material of the electrical component is selected from a group consisting of aluminum-titanium oxide, silicon nitride and silicon oxynitride.

7. The apparatus of claim 1, wherein the electrical component comprises a transistor that is coupled to a pixel of the display, wherein the electrical component is to control color output of the pixel based on a voltage applied to the pixel.

8. The apparatus of claim 1, wherein the electrical component comprises a large scale integrated circuit.

9. An apparatus comprising:
a wagering game machine comprising:
a wagering game unit operable to receive a wager in association with a wagering game; and
a touch screen to receive a user input for the wagering game, wherein a first electrical component of a control circuitry for the touch screen is embedded in the touch screen, wherein the first electrical component has an optical transmission of approximately 50% or greater.

10. The apparatus of claim 9, wherein the wagering game machine further comprises a graphical button to receive user input for a wagering game, a second electrical component is embedded in a display of the graphical button, wherein the second electrical component is substantially transparent to a part of the electromagnetic spectrum that is visible to a human eye.

11. The apparatus of claim 10, wherein the second electrical component is part of a control circuitry to control the display of the graphical button.

12. The apparatus of claim 10, wherein the display of the graphical button comprises an organic light emitting diode display.

13. The apparatus of claim 9, wherein the first electrical component has an optical transmission of approximately 90% or greater.

14. The apparatus of claim 9, wherein a material of the first electrical component is selected from a group consisting of ZnO, SnO₂, and In₂O₃.

15. The apparatus of claim 9, wherein a material of the first electrical component is selected from a group consisting of aluminum-titanium oxide, silicon nitride and silicon oxynitride.

16. An apparatus comprising:
a wagering game machine comprising,
a wagering game unit operable to receive a wager in association with a wagering game;
a display to display a randomly selected outcome of the wagering game;
a value input device is selected from the group consisting of a coin acceptor, a bill acceptor, a ticket reader and a barcode scanner, wherein the value input device comprises a bezel;
a button to receive player input for the wagering game;
wherein an electrical component, which is substantially transparent to a part of the electromagnetic spectrum that is visible to a human eye, is embedded in a part of the wagering game machine that is selected from the group consisting of the display, the value input device and the button.

17. The apparatus of claim 16, wherein the wagering game machine further comprises art glass, wherein the electrical component is embedded in the part of the wagering game machine that is selected from the group consisting of the display, the value input device, the button and the art glass.

18. The apparatus of claim 17, wherein the electrical component is to control an operation or illumination of the part of the wagering game machine in which the electrical component is embedded.

19. The apparatus of claim 16, wherein the electrical component comprises an integrated circuit.

20. The apparatus of claim 16, wherein the electrical component is selected from the group consisting of a processor, a digital-to-analog converter, a shifter and a smoothing circuitry.

21. The apparatus of claim 16, wherein the electrical component has an optical transmission of approximately 70% or greater.

22. A method comprising:
receiving, by a control circuitry having a substantially transparent electrical component that is embedded in a display of a wagering game machine, a game display signal that is an output from execution of a wagering game;
controlling, using the control circuitry, the display of the wagering game machine based on the game display signal.

23. The method of claim 22, further comprising receiving, by a different control circuitry having a substantially transparent electrical component that is embedded in a touch screen of the wagering game machine, a user input for the wagering game.

24. The method of claim 23, further comprising transmitting, by the different control circuitry, the user input to a processor in the wagering game machine that is executing the wagering game.

25. The method of claim 22, wherein a material of the substantially transparent electrical component is selected from a group consisting of ZnO, SnO₂, and In₂O₃.
